(19) United States
(12) Patent Application Publication
(10) Pub. No.: US 2011/0020185 A1
(43) Pub. Date: Jan. 27, 2011

(54) GAS FILTRATION STRUCTURE

(75) Inventors: Adrien Vincent, Cabannes (FR); Fabiano Rodrigues, Roussillon (FR); Atanas Chapkov, Caumont Sur Durance (FR); David Pinturaud, Isle Sur La Sorgue (FR); David Lechevalier, Cambridge, MA (US); Vignesh Rajamani, Marlborough, MA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN CENTRE DE RECH. ET D'ETUDES EUROPEEN, Courbevoie (FR)

(21) Appl. No.: 12/920,489

(22) PCT Filed: Mar. 10, 2009
(86) PCT No.: PCT/FR2009/050395

§ 371 Date: Sep. 1, 2010

(30) Foreign Application Priority Data
Mar. 11, 2008 (FR) 0851579

(51) Int. Cl. B01D 46/00; B23P 11/00

(52) U.S. Cl. 422/122; 55/522; 55/482; 29/428

(57) ABSTRACT

The subject of the invention is a gas filter structure for filtering particulate-laden gases, of the honeycomb type and comprising an assembly of longitudinal adjacent channels (21, 22) of mutually parallel axes separated by porous filtering walls (23), said channels (21, 22) being alternately blocked off at one or the other of the ends of the structure so as to define inlet channels (21) and outlet channels (22) for the gas to be filtered and so as to force said gas to pass through the porous walls (23) separating the inlet (21) and outlet (22) channels, said structure being such that, in cross section:
the ratio R of the sum of the areas of the inlet channels to the sum of the areas of the outlet channels is greater than 1;
at least some of the porous walls (23) are wavy so as to be concave relative to the center of the inlet channels (21) and convex in their middle relative to the center of the outlet channels (22); and
the outlet channels (22) possess at least one rounded corner (25).

The invention relates to the field of filtering structures that may possibly include a catalytic component, for example those used in an exhaust line of a diesel internal combustion engine.

Filters for the treatment of gases and for eliminating soot particles typically coming from a diesel engine are well known in the prior art. Usually these structures all have a honeycomb structure, one of the faces of the structure allowing entry of the exhaust gases to be treated and the other face allowing exit of the treated exhaust gases. The structure comprises, between the entry and exit faces, an assembly of adjacent ducts or channels, usually square in cross section, having mutually parallel axes separated by porous walls. The ducts are closed off at one or the other of their ends so as to define inlet chambers opening onto the entry face and outlet chambers opening onto the exit face. The channels are alternately closed off in such an order that the exhaust gases, in the course of their passage through the honeycomb body, are forced to pass through the sidewalls of the inlet channels for rejoining the outlet channels. In this way, the particulates or soot particles are deposited and accumulate on the porous walls of the filter body.

Currently, filters made of porous ceramic material, for example cordierite or alumina, especially aluminum titanate, mullite or silicon nitride or a silicon/silicon carbide mixture or silicon carbide, are used for gas filtration.

During its use, a particulate filter is subjected to a succession of filtration (soot accumulation) and regeneration (soot elimination) phases. During the filtration phases, the soot particles emitted by the engine are retained and deposited inside the filter.

During the regeneration phases, the soot particles are burnt off inside the filter, so as to restore its filtering properties. The porous structure is therefore subjected to intense radial, tangential and axial thermomechanical stresses that may result in micro-cracks liable, over the duration, to result in the unit suffering a severe loss of filtration capacity, or even its complete deactivation. This phenomenon is observed in particular in large-diameter monolithic filters.

To solve these problems and increase the lifetime of the filters, it has been proposed more recently to provide filter structures made up from combining several honeycomb blocks or monoliths. The monoliths are usually bonded together by means of an adhesive or cement of ceramic nature, hereafter in the description called joint cement. Examples of such filtering structures are in particular described in the patent applications EP 816 065, EP 1 142 619, EP 1 455 923, WO 2004/090294 or WO 2005/063462. To ensure optimum relaxation of the stresses in such an assembled structure, it is known that the thermal expansion coefficients of the various parts of the structure (filter monoliths, coating cement, joint cement) must be substantially of the same order of magnitude. Consequently, said parts are advantageously synthesized on the basis of the same material, usually silicon carbide SiC or cordierite. This choice also ensures uniform heat distribution during regeneration of the filter.

To obtain the best performance in terms of thermomechanical strength and pressure drop, the assembled filters currently available for light vehicles typically comprise about 10 to 20 monoliths having a square, rectangular or hexagonal cross section, the elementary cross-sectional area of which is between about 13 cm² and about 25 cm². These monoliths consist of a plurality of channels usually of square cross section.

In general, there is therefore at the present time a need to increase both the overall filtration performance and the lifetime of current filters.

More precisely, the improvement of filters may be directly measured by comparing the following properties, the best possible compromise between these properties being sought for equivalent engine speeds:

a low pressure drop caused by a filtering structure in operation, i.e. typically when it is in an exhaust line of an internal combustion engine, both when such structure is free of soot particles (initial pressure drop) and when it is laden with particles;

the lowest possible increase in the pressure drop of the filter during said operation, i.e. a small increase in the pressure drop as a function of the operating time or more precisely as a function of the level of soot loading of the filter;

a high specific surface area for filtration;

a monolith mass suitable for ensuring a sufficient thermal mass for minimizing the maximum regeneration temperature and the thermal gradients undergone by the filter, which may themselves induce cracks in the monolith;

a substantial soot storage volume, especially at constant pressure drop, so as to reduce the frequency of regeneration;

a high thermomechanical strength, i.e. allowing a prolonged lifetime of the filter; and

a higher residue storage volume.

The increase in pressure drop as a function of the level of soot loading of the filter can especially be measured directly by the loading slope ΔP/Mₛₒₒₜ, in which ΔP represents the pressure drop and Mₛₒₒₜ represents the mass of soot accumulated in the filter.

Patent application WO 05/016491 has proposed filter monoliths in which the inlet and outlet channels are of different shape and different internal volume. In such structures, the wall elements follow one another in cross section and along a horizontal and/or vertical row of channels so as to define a sinusoidal or wavy shape. The wall elements form a wave typically with a sinusoidal half-period over the width of a channel.

The thermal mass of filters of this type known from the prior art is used to limit the thermal gradients and therefore to avoid thermal shocks during the regeneration phase.

Moreover, the conversion of the gas-phase polluting emissions (i.e. mainly carbon monoxide (CO) and unburnt hydrocarbons (HCs) or even nitrogen oxides (NOₓ) or sulfur oxides (SOₓ)) into less harmful gases (such as water vapor, carbon dioxide (CO₂) or gaseous nitrogen (N₂)) requires an additional catalytic treatment. The most developed current filters thus also have a catalytic component. The catalytic function is in general obtained by impregnating the honeycomb structure with a solution comprising the catalyst or a precursor of the catalyst, generally based on a precious metal of the platinum group. Additionally or alternatively, the catalyst may be introduced into the fuel.

Such catalytic filters are effective for the treatment of polluting gases as soon as the temperature reached within the filter is above the minimum activity temperature of the catalyst. A light-up temperature or activation temperature is also defined, this corresponding, for given gas pressure and flow rate conditions, to the temperature at which a catalyst converts 50% by volume of the polluting gases into nonpolluting species. Depending on the gas pressure and flow rate conditions, this temperature generally varies between about 100° C. and about 240° C. for an SiC-based filter having a catalyst based on a noble metal of the platinum family. When the filter is subjected to colder gases, for example during the first few minutes of use of the vehicle after a stoppage, the degrees of conversion rapidly drop since the temperature of the filter may fall below the activation temperature. It is possible to define, with sufficient precision, what is called the light-down time or deactivation time, corresponding to the time needed for the hot filter to substantially reach, upon cooling down, on average and throughout its volume, the light-up temperature of the catalyst. This period is characteristic of a given filter and of the catalyst used, whether this catalyst is deposited beforehand on the filter or introduced into the fuel.

Because of the large number of motor vehicles in circulation, an increase, even a minimal one, in this time, for example of around one second, would make it possible for the gaseous polluting emissions to be very substantially reduced and thus represent a considerable technical advance.

However, it is essential that such a reduction does not appreciably degrade the other properties characterizing the filter in operation, i.e. mainly the properties as defined above.

One object of the invention is to provide a filter structure which, for a constant mass, has a better filtration efficiency, in particular in terms of light-down time, and a lower loading slope than the structures known from the prior art.

For this purpose, one subject of the invention is a gas filter structure for filtering particulate-laden gases, of the honeycomb type and comprising an assembly of longitudinal adjacent channels of mutually parallel axes separated by porous filtering walls, said channels being alternately blocked off at one or the other of the ends of the structure so as to define inlet channels and outlet channels for the gas to be filtered and so as to force said gas to pass through the porous walls separating the inlet and outlet channels, said structure being such that, in cross section:

the ratio R of the sum of the areas of the inlet channels to the sum of the areas of the outlet channels is greater than 1;

at least some of the porous walls are wavy so as to be concave relative to the center of the inlet channels and convex in their middle relative to the center of the outlet channels; and

the outlet channels possess at least one rounded corner.

The wavy walls represent at least one quarter, or even one half, of the walls of the structure, it being possible for example for the other walls to be straight. When all the walls are not wavy, it is preferred, along a given axis, for all the walls or one wall in two to be wavy. If all the walls along an axis are wavy, the walls along the perpendicular axis being straight, each inlet channel may possess two facing walls that are concave relative to its center, each outlet channel possessing two facing walls that are convex in their middle relative to the center of the channel. If, along a given axis, only one wall in two is wavy, each inlet channel now possesses only one concave wall relative to its center, and each outlet channel now possesses only one convex wall at its middle relative to the center of the channel. Other configurations are possible, for example those in which, along two axes, one wall in two is wavy, the channels possessing two concave or convex contiguous walls and two straight walls.

According to one preferred embodiment, all the porous walls are wavy so as to be concave relative to the center of the inlet channels and convex in their middle relative to the center of the outlet channels. According to an alternative embodiment, the structure is such that, in a cross section, the porous walls along a first axis are straight, whereas the porous walls along a second axis, perpendicular to the first axis, are wavy so as to be concave relative to the center of the inlet channels and concave at their middle relative to the center of the outlet channels.

Preferably, the waves are sinusoidal, especially such that the ratio T of the amplitude (h) to the half-period (p) is less than or equal to 0.2, especially less than or equal to 0.15. The amplitude h is defined as the distance between the highest point of the sinusoid and the lowest point thereof. The ratio T is preferably less than or equal to 0.12 and/or greater than or equal to 0.05, especially 0.07 and even 0.09. Too high a ratio runs the risk of overly limiting the volume of the outlet channels, leading to an increase in pressure drop, and runs the risk of making it more difficult to manufacture the filters. Too low a ratio brings the structure too close to a conventional structure having square channels and plane walls to be able to fully benefit from all the advantages associated with the invention.

Preferably, the half-period of the sinusoidal walls is equal to the period of the filter structure. The period of the filter structure is defined as the distance between the center of an outlet channel and the center of an inlet channel adjacent this outlet channel. In this way, at least two walls (and especially the four walls) defining an outlet channel each have a single convexity relative to the center of the channel and at least two walls (and especially the four walls) defining an inlet channel each have a single concavity relative to the center of the channel.

Preferably, the ratio R is between 1.1 and 2.0. The structure obtained may be termed asymmetric in the sense that the overall volume of the inlet channels is greater than the overall volume of the outlet channels. This configuration makes it possible to increase the available area for filtration and/or catalysis, thereby reducing the pressure drop of the filters and the soot loading slope.

The outlet channels preferably possess two, or at least two, rounded corners and preferably four rounded corners. All the corners are preferably rounded. The outlet channels preferably possess four corners, in particular all rounded. Their cross section is in this case bounded by at least two (and especially four) convex walls in their middle relative to the center of the channel.

The radius of curvature of the or each rounded corner of the outlet channels is preferably such that the ratio of the period of the filter structure to the radius of curvature is between 1.5 and 1000, preferably between 2 and 500 and even more preferably between 4 and 100, or even between 5 and 20. Too high a radius of curvature has a detrimental effect on the pressure drop, whereas too low a radius of curvature prevents the advantages associated with the invention from being obtained in a fully satisfactory manner.

The inlet channels may also have one or more rounded corners, especially 1, 2, 3 or 4 rounded corners. The rounded corners may also have a radius of curvature such that the ratio of the period of the filter structure to the radius of curvature is between 1.5 and 1000, preferably between 2 and 500 and even more preferably between 4 and 100, or even between 5 and 20. However, this feature is not preferred as it could lead to an increase in the thermal inertia of the filters. Admittedly this may help to improve the thermomechanical resistance of the filter, but to the detriment of the activation time of the catalyst. Preferably, the inlet channels therefore do not have rounded corners.

The core of a wall is defined as an imaginary line which, in a cross section, divides a given wall into two portions of equal thickness. The distance E_{c} is defined as the distance between the corner of an outlet channel and the point of intersection between the two wall cores closest to said corner. The distance Eₘᵢₙ is defined as the minimum distance, for a given channel, between the internal surface of the wall and the core of this wall. Preferably, the E_{c}/Eₘᵢₙ ratio is equal to or greater than 3, especially equal to or greater than 3.1.

The cross section of the channels is preferably constant over the entire length of the structure. It is also preferable for the sections of all the outlet channels to be identical, with the possible exception of the channels located on the periphery of the filter structure or the channels of the structures located on the periphery of the filter. The same feature is also preferred in respect of the inlet channels.

To ensure good filtration capacity without overly increasing the pressure drop, the thickness of the walls is preferably between 150 and 500 microns, especially between 200 and 500 microns, or even between 300 and 400 microns. Likewise, the density of channels is preferably between 1 and 280 channels per cm², especially between 15 and 65 channels per cm².

The porosity of the material constituting the filtering walls of the filter is preferably between 30 and 70% by volume and/or the median pore diameter is preferably between 5 and 40 μm.

The walls are preferably based on silicon carbide, which exhibits very good chemical and high-temperature resistance. The walls may also be made of a material chosen from cordierite, alumina, aluminum titanate, mullite, silicon nitride, sintered metals, a silicon/silicon carbide mixture, or any one of their mixtures.

At least part, or even the totality, of the surface of the inlet channels is preferably coated with a catalyst intended to promote elimination of the polluting gases (such as CO, HC, NOₓ) and/or of the soot particles.

At least one active catalytic phase, preferably comprising a precious metal such as Pt, Pd, Rh and optionally an oxide chosen from CeO₂, ZrO₂ or one of their mixtures, may thus be deposited, preferably by impregnation, on the filter structure described above. Usually, the active principle is deposited using techniques well known in heterogeneous catalysis into the pores of a support layer, generally based on an oxide having a high specific surface area, for example alumina, titanium oxide, silica, cerium oxide or zirconium oxide.

Another subject of the invention is an assembled filter comprising a plurality of filter structures as described above, said structures being bonded together by a cement. The structures may be, in cross section, of square, rectangular, triangular or even hexagonal shape. A hexagonal shape has the advantage of improving the thermomechanical resistance of the filter for a constant mass and thereby makes it possible to use larger monolithic structures.

Yet another subject of the invention is the use of a filter structure or of an assembled filter as described above as pollution control device on an exhaust line of a diesel or gasoline engine, preferably a diesel engine.

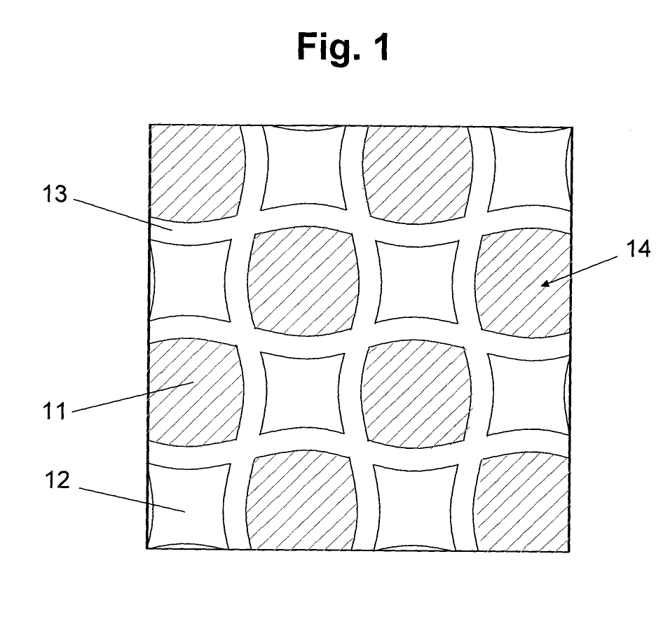

FIGS. 1 to 6 and the nonlimiting examples that follow enable the invention and its advantages to be better understood.

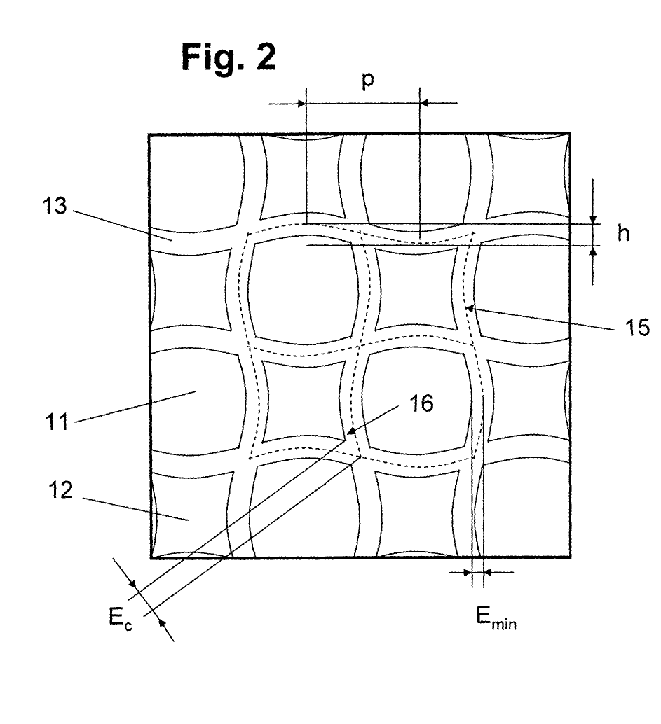

FIGS. 1 and 2 are front elevation views of a portion of the gas exit face of a filter according to the prior art.

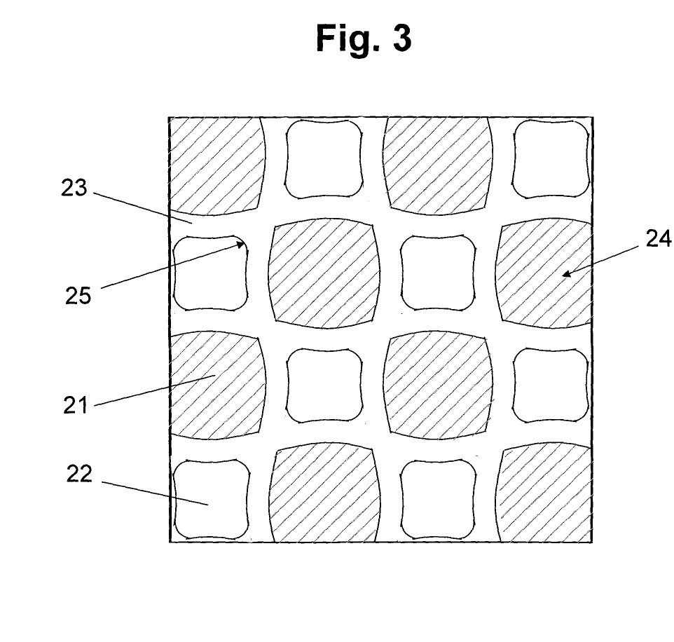

FIGS. 3 to 5 are front elevation views of a portion of the gas exit face of a filter according to the invention.

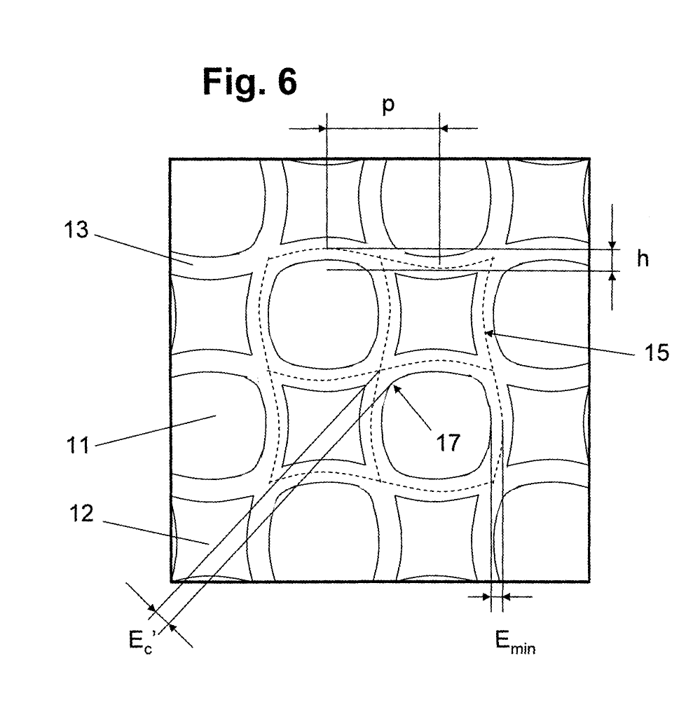

FIG. 6 is a front elevation view of a portion of the gas exit face of a filter according to a comparative example, which will be discussed later.

FIG. 1 shows a portion of the exit face of a filter structure according to the prior art, especially according to patent application WO 2005/016491. The structure is of the honeycomb type and comprises a set of adjacent longitudinal channels 11 and 12, of mutually parallel axes, separated by porous filtering walls 13. The channels 11, 12 are alternatively blocked off by plugs 14 at one or other of the ends of the structure so as to define inlet channels 11 and outlet channels 12 for the gas to be filtered, and so as to force said gas to pass through the porous walls 13. Since the face shown is a gas exit face (rear face of the filter), the plugs 14 block off the inlet channels 11. In contrast, on the opposite face (the front face or gas entry face), it is the outlet channels 12 that are blocked off.

The structure shown in FIG. 1 is such that, in cross section, the porous walls 13 have sinusoidal waves so that said porous walls 13 are concave relative to the center of the inlet channels 11 and convex relative to the center of the outlet channels 12. The ratio R is around 1.6.

FIG. 2 repeats the structure of FIG. 1, the plugs 14 no longer being shown. The core 15 of a few walls 13 is shown by the dotted lines and repeats the sinusoidal wave form of the walls 13. The amplitude h and the half-period p of the sinusoid are shown schematically in the figure, together with the parameters E_{c} and Eₘᵢₙ. As indicated previously, the distance E_{c} is defined as the distance between the corner 16 of an outlet channel 12 and the point of intersection between the two wall cores closest to said corner 16. The distance Eₘᵢₙ is defined as the minimum distance, for a given channel, between the internal surface of the wall and the core 15 of this wall 13. In the structure shown in FIGS. 1 and 2, the ratio E_{c}/Eₘᵢₙ is around 2.

FIG. 3 illustrates a filter structure according to the invention.

The structure is of the honeycomb type and comprises a set of longitudinal adjacent channels 21 and 22, of mutually parallel axes, separated by porous filtering walls 23. The channels 21 and 22 are alternately blocked off by plugs 24 at one or other of the ends of the structure so as to define inlet channels 21 and outlet channels 22 for the gas to be filtered, and so as to force said gas to pass through the porous walls 23. Since the face shown is the gas exit face (the rear face of the filter), the plugs 24 block off the inlet channels 21. In contrast, on the opposite face (the front face or gas entry face), it is the outlet channels 22 that are blocked off.

In cross section, the porous walls 23 are in the form of sinusoidal waves so that said porous walls 23 are concave relative to the center of the inlet channels 21 and convex at their middle relative to the center of the outlet channels 22. The ratio R is around 1.7.

The outlet channels 22 possess four corners 25, all rounded, which consequently define four curves located at each corner 25 of the channel, these being concave relative to the center of the channel 22. Of course, other embodiments are possible, in which the number of rounded corners per outlet channel 22 is two or even three.

The four walls 23 defining each outlet channel 22 each have a single convexity in their middle relative to the center of the channel 22 and the four walls 23 defining an inlet channel 21 each have a single concavity relative to the center of the channel 21.

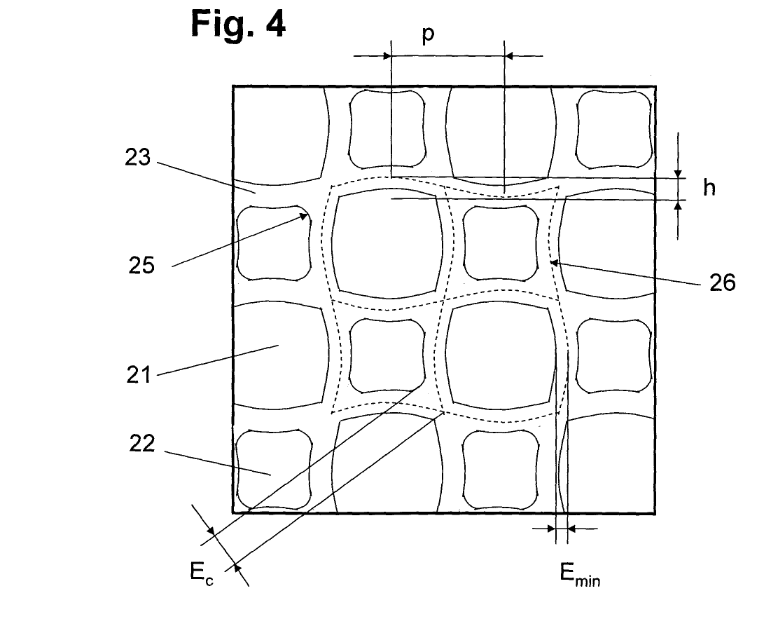

Shown schematically in FIG. 4 are the parameters E_{c} and Eₘᵢₙ. Owing to the surplus material at the corners of the outlet channels 22, the ratio E_{c}/Eₘᵢₙ is higher than in the structures of the prior art, in this case greater than 3. The core of some of the walls is shown by dotted lines 26.

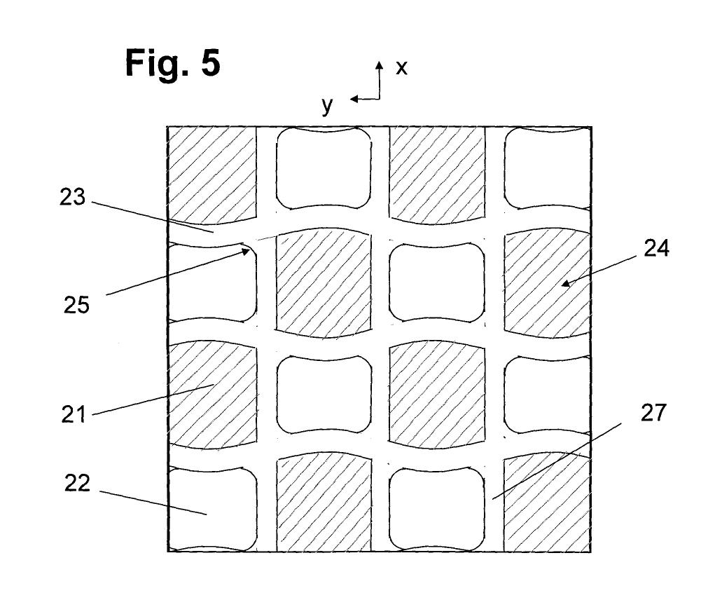

FIG. 5 illustrates another embodiment, in which the porous walls 27 along a first axis x are straight, whereas the porous walls 23 along a second axis y, perpendicular to the first axis x, are wavy so as to be concave relative to the center of the inlet channels 21 and convex at their middle relative to the center of the outlet channels 22. In this way, each outlet channel 22 is bounded by two facing straight walls 27 and by two wavy walls 23, which are convex at their middle relative to the center of the channel. Each inlet channel 21 is itself bounded by two straight walls 27 facing each other and by two wavy walls 23 again facing each other and concave relative to the center of the channel.

FIG. 6 illustrates a filter according to a comparative example, and therefore outside the invention. In the configuration shown, only the inlet channels have rounded corners 17. The distance E_{c}′ may be defined as the distance between the corner 17 of an inlet channel 11 and the point of intersection between the two wall cores closest to said corner 17.

The invention and its advantages over the structures already known will be more clearly understood on reading the following nonlimiting examples.

### EXAMPLE 1 (COMPARATIVE EXAMPLE)

A first population of honeycomb-shaped monoliths made of silicon carbide was synthesized according to the prior art, for example that described in the patents EP 816 065, EP 1 142 619, EP 1 455 923 or WO 2004/090294.

To do this, in a similar manner to that of the process described in EP 1 142 619, 70% by weight of an SiC powder, the grains of which had a median diameter d₅₀ of 10 microns, was firstly mixed with a second SiC powder, the grains of which had a median diameter d₅₀ of 0.5 microns. Within the present description, the term “median pore diameter d₅₀” is understood to mean the diameter of the particles such that respectively 50% of the total population of the grains has a size smaller than this diameter. A pore former of polyethylene type was added to this mixture in a proportion equal to 5% by weight of the total weight of the SiC grains together with a shaping additive of methylcellulose type in a proportion equal to 10% by weight of the total weight of the SiC grains.

Next, the necessary amount of water was added and, by mixing, a homogeneous paste was obtained that had a plasticity enabling it to be extruded through a die configured so as to obtain monolith blocks of square cross section, the internal channels of said monolith blocks having the cross section illustrated schematically in FIG. 1. The half-period p of the waves was 1.95 mm and corresponded to the period of the filter structure. The ratio T was 0.11.

The green monoliths obtained were microwave-dried for a time long enough to bring the content of chemically non-bound water to less than 1% by weight.

The channels of each face of the monolith were alternately blocked using well-known techniques, for example those described in the application WO 2004/065088.

The monoliths were then fired in argon with a temperature rise of 20° C./hour until a maximum temperature of 2200° C. was obtained, this being maintained for 6 hours.

The porous material obtained had an open porosity of 47% and a median pore diameter of around 15 microns.

An assembled filter was then formed from the monoliths. Sixteen monoliths obtained from the same mixture were assembled together using conventional techniques by bonding using a cement having the following chemical composition: 72 wt % SiC, 15 wt % Al₂O₃, 11 wt %, SiO₂, the remainder consisting of impurities, predominantly Fe₂O₃ and alkali and alkaline-earth metal oxides. The average thickness of the joint between two neighboring blocks was around 2 mm. The whole assembly was then machined so as to constitute assembled filters of cylindrical shape with a diameter of about 14.4 cm.

The dimensional characteristics of the monoliths thus obtained are given in Table 1 below.

Using the conventional techniques for depositing the polluting-gas conversion catalyst, fired monoliths were also impregnated with a catalytic solution comprising platinum, and then dried and heated.

Chemical analysis showed a total Pt concentration of 40 g/ft³ (1 g/ft³=0.035 kg/m³), i.e. 3.46 grams uniformly distributed over the various parts of the filter.

### EXAMPLE 2 (COMPARATIVE EXAMPLE)

The monolith synthesis technique described above was repeated in the same way, but this time the die was designed to produce monolith blocks characterized by an arrangement such that the inlet channels (and not the outlet channels) have rounded corners. This arrangement is illustrated by FIG. 6.

As indicated above, the dimensional characteristic E_{c}′ is equivalent to the characteristic E_{c} in the case of the inlet channels.

### EXAMPLE 3 (ACCORDING TO THE INVENTION)

The monolith synthesis technique described above was again repeated in the same way, but this time the die was designed to produce monolith blocks characterized by an arrangement of the type shown schematically in FIG. 3, in which the outlet channels have rounded corners. In cross section, the wave of the walls is characterized by a ratio T of 0.11.

The dimensional characteristics of the monoliths thus obtained are given in Table 1 below.

TABLE 1

| Example | 1 | 2 | 3 |
|---|---|---|---|
| Geometry | FIG. 1 | FIG. 6 | FIG. 3 |
| Width of the square | 35.8 | 35.8 | 35.8 |
| cross-section | | | |
| monoliths (mm) | | | |
| Length of the | 20.32 | 20.32 | 20.32 |
| monoliths (cm) | | | |
| Period (mm) | 1.95 | 1.95 | 1.95 |
| Ratio T | 0.11 | 0.11 | 0.11 |
| Wall thickness (μm) | 360 | 340 | 340 |
| Radius of curvature of | — | — | 0.25 |
| the outlet channel | | | |
| corners (mm) | | | |
| Eₘᵢₙ (μm) | 180 | 170 | 170 |
| E_{c} (μm) | 435 | 410 | 610 |
| E_{c}/Eₘᵢₙ | 2.42 | 2.41 | 3.59 |
| Radius of curvature of | — | 0.75 | — |
| the inlet channel | | | |
| corners (mm) | | | |
| E_{c}′ (μm) | 195 | 280 | 180 |
| E_{c}′/Eₘᵢₙ | 1.08 | 1.65 | 1.06 |

The specimens obtained were evaluated and characterized according to the following operating methods:

### Dimensional Characteristics

Table 2 below indicates, for each example, the following dimensional characteristics:

the OFA (open front area) was obtained by calculating the percentage ratio of the area covered by the sum of the cross sections of the inlet channels of the front face of the monoliths (excluding the walls and plugs) to the total area of the corresponding cross section of said monoliths. The residue storage volume is greater the higher this percentage;

the WALL is the ratio, in one cross section and as a percentage, of the area occupied by all of the walls of a monolith (excluding the plugs) to the total area of said cross section; and

the specific filtration surface area of the filter (monolith or assembled filter) corresponds to the internal surface area of all of the walls of the inlet filtering channels expressed in m² relative to the volume of the filter in m³, where appropriate incorporating its external coating. The soot storage volume is greater the higher the specific surface area thus defined.

### Pressure Drop and Loading Slope Measurement

The term “pressure drop” is understood, in the context of the present invention, to mean the differential pressure existing between the upstream side and the downstream side of the filter. The pressure drop was measured using the techniques of the art for a gas flow rate of 250 kg/h and a temperature of 250° C. on fresh filters (i.e. not laden with soot).

To measure the pressure drop on soot-laden filters, the various filters were firstly fitted into an exhaust line of a 2-liter engine operating at full power (4000 rpm) for 30 minutes, after which they were removed and weighed so as to determine their initial mass. The filters were then put back on the engine test bed and run at a speed of 3000 rpm and a torque of 50 Nm so as to obtain soot loadings of 7 g/l in the filters. The pressure drop on the filters thus laden with soot was measured as in the case of the fresh filters. The pressure drop was also measured as a function of the various degrees of loading between 0 and 10 g/l so as to establish the loading slope ΔP/Mₛₒₒₜ.

As indicated in Table 2, the following ratings were assigned to each of the filters according to the following scale:

+++: very high loading slope;

++: high loading slope;

+: moderate loading slope;

−: low loading slope.

### Light-Down Time Measurement

The purpose of this test was to measure the light-up temperature of the catalyst. This CO/HC conversion temperature was determined here using the experimental protocol identical to that described in patent application EP 1 759 763, in particular in paragraphs 33 and 34 thereof. The test was carried out on specimens of fired monoliths impregnated with catalyst as described above.

After catalyst activation and stabilization of the average temperature of the monolith at 400° C., the stream of gas to be depolluted was cooled at a constant gas mass flow rate of 60 kg/h from 400° C. to 150° C. The time required for the monolith to reach its average temperature equal to the light-up temperature of the catalyst was then measured.

The results obtained in the case of Examples 1 to 3, which are directly comparable, are indicated in Table 2.

TABLE 2

| Example | 1 | 2 | 3 |
|---|---|---|---|
| OFA (%) | 47.2 | 46.5 | 48.0 |
| WALL (%) | 33.4 | 33.4 | 33.4 |
| Specific filtration | | | |
| surface area (m²/m³) | 907 | 881 | 915 |
| Pressure drop (mbar) | 37.2 | 36.0 | 38.7 |
| Loading slope | ++ | +++ | − |
| Measured average | 151 | 156.5 | 154.5 |
| monolith light-down | | | |
| time (s) | | | |

The filter according to the invention has an open front area and a specific filtration surface area that are higher than those of the filter of the prior art (Example 1) for the same WALL, and therefore the same monolith mass. This change of geometry, consisting of a local increase in the wall thickness in the outlet channels, has the effect of significantly increasing the catalytic activity light-down time. Although the pressure drop in the unladen state is slightly higher, while still remaining acceptable, the loading slope itself is lower than for the reference filter. This is favorable to reducing fuel overconsumption due to the presence of the filtration device. Compared with the comparative filter according to Example 2, the filter according to the invention has a shorter light-down time and a higher pressure drop, while still remaining perfectly acceptable for the application. On the other hand, compared with Example 2, the filter according to the invention has an open front area and a specific filtration surface area that are significantly higher and, most particularly, an appreciably lower loading slope.

The filter according to the invention therefore has the best compromise with regard to the various properties required.

1. A gas filter structure for filtering a particulate-laden gas, having a honeycomb pattern and comprising an assembly of longitudinal adjacent channels of mutually parallel axes separated by porous filtering walls, said channels being alternately blocked off at one or the other of the ends of the structure so as to define inlet channels and outlet channels for the gas to be filtered and so as to force said gas to pass through the porous filtering walls separating the inlet and outlet channels, said structure being such that, in cross section:
a ratio R of a sum of areas of the inlet channels to a sum of areas of the outlet channels is greater than 1;
at least some of the porous filtering walls are wavy so as to be concave relative to the center of the inlet channels and convex in their middle relative to the center of the outlet channels; and
the outlet channels comprise at least one rounded corner.

2. The filter structure as claimed in claim 1, such that all the porous filtering walls are wavy so as to be concave relative to the center of the inlet channels and convex in their middle relative to the center of the outlet channels.

3. The filter structure as claimed in claim 1, in which the porous filtering walls which are wavy are sinusoidal in shape.

4. The filter structure as claimed in claim 3, wherein a ratio T of the amplitude (h) to the half-period (p) is less than or equal to 0.2.

5. The filter structure as claimed in claim 1, such that the ratio R is between 1.1 and 2.0.

6. The filter structure as claimed in claim 1, in which the outlet channels comprise four corners, which are all rounded.

7. The filter structure as claimed in claim 1, in which the radius of curvature of the or each rounded corner of the outlet channels is such that a ratio of the period of the filter structure to the radius of curvature is between 1.5 and 1000.

8. The filter structure as claimed in claim 1, such that the cross section of the channels is constant over the entire length of the structure.

9. The filter structure as claimed in claim 1, in which the thickness of the porous filtering walls is between 150 and 500 microns.

10. The filter structure as claimed in claim 1, in which the density of channels is between 1 and 280 channels per cm².

11. The filter structure as claimed in claim 1, in which the porous filtering walls comprise silicon carbide or at least one material selected from the group consisting of cordierite, alumina, aluminum titanate, mullite, silicon nitride, sintered metals, and a silicon/silicon carbide mixture.

12. The filter structure as claimed in claim 1, in which at least part of the surface of the inlet channels is coated with a catalyst.

13. An assembled filter comprising a plurality of filter structures as claimed in claim 1, wherein said structures are bonded together by a cement.

14. A process for manufacturing an exhaust line, the process comprising incorporating a filter structure or of an assembled filter as claimed in claim 1 onto or into an exhaust line of an engine.

15. The filter structure as claimed in claim 3, wherein a ratio T of the amplitude (h) to the half-period (p) is less than or equal to 0.15.

16. The filter structure as claimed in claim 2, in which the porous walls which are wavy are sinusoidal in shape.

17. The filter structure as claimed in claim 15, wherein a ratio T of amplitude (h) to half-period (p) is less than or equal to 0.2.

18. The filter structure as claimed in claim 15, wherein a ratio T of the amplitude (h) to the half-period (p) is less than or equal to 0.15.

19. The filter structure as claimed in claim 2, such that the ratio R is between 1.1 and 2.0.

20. The filter structure as claimed in claim 3, such that the ratio R is between 1.1 and 2.0.
